(19) United States
(12) Patent Application Publication
(10) Pub. No.: US 2015/0200040 A1
(43) Pub. Date: Jul. 16, 2015

(54) COMPOSITE CABLE

(71) Applicant: YFC-BONEAGLE Electric Co., Ltd., Taoyuan County (TW)

(72) Inventors: Wen-Fu PON, Taoyuan County (TW); Chun-Chieh CHEN, Taoyuan County (TW); Ying-Ming KU, Taoyuan County (TW)

(73) Assignee: YFC-BONEAGLE Electric Co., Ltd., Taoyuan County (TW)

(21) Appl. No.: 14/152,173

(22) Filed: Jan. 10, 2014

(51) Int. Cl. H01B 11/10; H01B 11/18

(52) U.S. Cl. CPC H01B 11/1033; H01B 11/1895; H01B 11/1091

(57) ABSTRACT

A composite cable includes an insulating outer layer having a hollow chamber and a plurality of transmission lines passed into the hollow chamber, and each being used specifically for a plurality of transmission interfaces. The transmission line includes a first transmission line having a first wire covered onto the exterior of the first aluminum foil layer, a first metal braid covered onto the exterior of the first aluminum foil layer, a first ground wire installed between the first aluminum foil layer and the first metal braid, and a second transmission line having a second wire and a second metal braid covered onto the exterior of the second wire. Therefore, the same composite cable has the transmission lines and a multiple of functions that can reduce interference with each other during data transmissions, so as to assure and maintain the original high quality of video, audio or data signals.

### FIELD OF THE INVENTION

The present invention relates to a cable, and more particularly to a composite cable having a plurality of transmission lines and each transmission line can be used for different transmission interfaces.

### BACKGROUND OF THE INVENTION

A transmission line is mainly divided into a High Definition Multimedia Interface (HDMI) transmission line specifically for a HDMI transmission interface, a Universal Serial Bus (USB) transmission line specifically used for a USB transmission interface, and a Radio Frequency (RF) coaxial cable specifically used for a RF transmission interface, and different transmission interfaces required specified transmission lines to produce different functions respectively.

At present, there are more and more electronic products adopting a multifunctional design, so that it is necessary to employ at least two transmission interfaces such as the HDMI and USB transmission interfaces, or the HDMI and RF transmission interfaces, or the HDMI, USB and RF transmission interfaces, but the conventional transmission lines simply have a single function and fail to meet the user requirements, and thus causing inconvenience of use.

In view of the aforementioned drawbacks of the prior art, the inventor of the present invention based on years of experience in the related industry to conduct extensive researches and experiments, and finally designed a feasible solution to overcome the drawbacks of the prior art.

### SUMMARY OF THE INVENTION

Therefore, the present invention is to provide a composite cable having a plurality of transmission lines and a multiple of functions in the same cable, and further transmitting data through different transmission lines of the cable while reducing interferences between the transmission lines, so as to assure and maintain the original high quality of video, audio and data signals.

Accordingly, the present invention provides a composite cable, comprising: an insulating outer layer, having a hollow chamber; and a plurality of transmission lines, passed into the hollow chamber, and each of the transmission lines being used specifically for a plurality of transmission interfaces, and the transmission lines comprising: at least one first transmission line, having a plurality of first wires, a first aluminum foil layer covered onto the exterior of the first wires, a first metal braid covered onto the exterior of the first aluminum foil layer, and a first ground wire installed between the first aluminum foil layer and the first metal braid; and at least one second transmission line, having at least one second wire and a second metal braid covered onto the exterior of the at least one second wire.

Compared with the prior art, the present invention has the following effects:

The invention not just provides a plurality of transmission lines and a multiple of functions in the same cable only, but also transmits data through different transmission lines of the cable while reducing interferences occurred between the transmission lines, so as to assure and maintain the original high quality of video, audio and data signals.

### BRIEF DESCRIPTION OF THE DRAWINGS

FIG. 1 is a sectional view of a composite cable of a first preferred embodiment of the present invention; and

FIG. 2 is a sectional view of a composite cable of a second preferred embodiment of the present invention.

### DESCRIPTION OF THE PREFERRED EMBODIMENTS

The technical contents of the present invention will become apparent with the detailed description of preferred embodiments accompanied with the illustration of related drawings as follows. It is noteworthy that same numerals are used for representing same respective elements in the drawings.

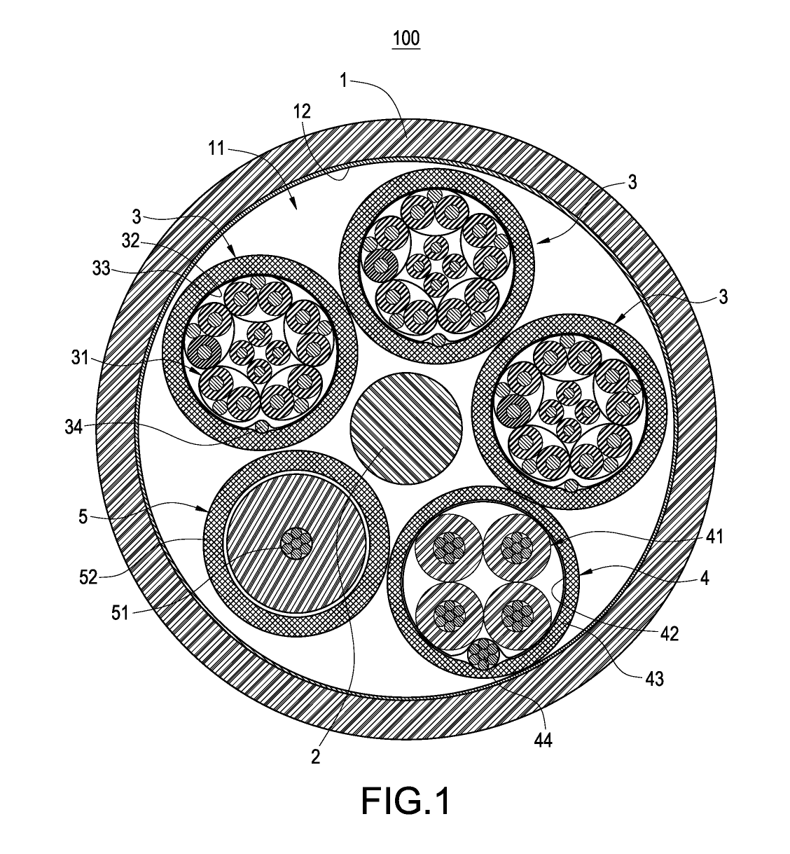

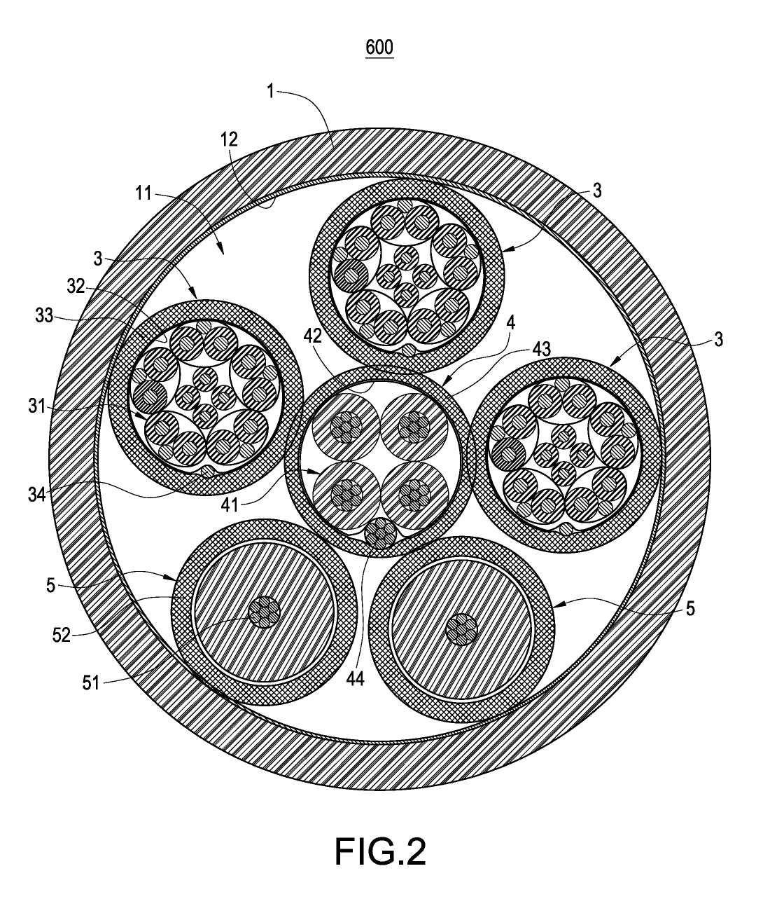

With reference to FIGS. 1 and 2 for the sectional views of the first and second preferred embodiments of a composite cable of the present invention respectively, the composite cable 100, 600 can be used in different transmission interfaces. The transmission interfaces are not labelled in the figures, but the sectional views show that these transmission lines 3, 4, 5 are the transmission lines used for a HDMI transmission interface, a USB transmission interface and a RF transmission interface respectively.

In the sectional view of the composite cable 100 of the first preferred embodiment of the present invention as shown in FIG. 1, the composite cable 100 comprises an insulating outer layer 1 and a plurality of transmission lines, and preferably further comprises an insulating tube 2. The transmission lines includes at least one first transmission line 3 and at least one second transmission line 4, or includes at least one first transmission line 3 and at least one second transmission line (5). However, the present invention is not limited to any of the aforementioned arrangements, and the figure shows the former configuration. In this preferred embodiment, the transmission lines includes a plurality of first transmission lines 3 and a second transmission line 4, and preferably further includes a third transmission line 5.

The insulating outer layer 1 is a hollow body having a hollow chamber 11. Preferably, a mylar layer 12 is attached onto an inner edge of the insulating outer layer 1 to improve the insulating effect and reducing external interferences.

The transmission lines are passed into the hollow chamber 11, and each transmission line is specifically used for each different transmission interface such as a high definition multimedia interface (HDMI) transmission interface, a universal serial bus (USB) transmission interface, a radio frequency (RF) transmission interface, etc.

The first transmission line 3 is specifically used for a first transmission interface (which is the HDMI transmission interface as shown in the figure, so that the first transmission line 3 is a HDMI transmission line in this preferred embodiment) and has a plurality of first wires 31 covered onto a first aluminum foil layer 32 at the exterior of the first wires 31, a first metal braid 33 covered onto the exterior of first aluminum foil layer 32, and a first ground wire 34 installed between the first aluminum foil layer 32 and the first metal braid 33 (wherein four other wires not labeled in the figure are included between the first wires 31), so that all of the first wires 31 are covered by the first aluminum foil layer 32 first, and then covered by the first metal braid 33 at the outermost layer. In addition, the first ground wire 34 is clamped between the first aluminum foil layer 32 and the first metal braid 33, so that the first ground wire 34 is electrically contacted with the first aluminum foil layer 32 and the first metal braid 33 to reduce interferences between the first transmission line 3 and other transmission lines as well as reducing external interference from other transmission lines to the first transmission line 3.

The second transmission line 4 is specifically used for a second transmission interface (which is the USB transmission interface as shown in the figure, so that the second transmission line 4 is a USB transmission line used in this preferred embodiment) and has a plurality of second wires 41, a second aluminum foil layer 42 covered onto the exterior of the second wires 41, a second metal braid 43 covered onto the exterior of the second aluminum foil layer 42, and a second ground wire 44 installed between the second aluminum foil layer 42 and the second metal braid 43, so that all of the second wires 41 are covered by the second aluminum foil layer 42 first, and then covered by the second metal braid 43 at the outermost layer (In other words, the second metal braid 43 is disposed apart from the second aluminum foil layer 42 and covered onto the exterior of the second wires 41). In addition, the second ground wire 44 is clamped between the second aluminum foil layer 42 and the second metal braid 43, so that the second ground wire 44 is electrically contacted with the second aluminum foil layer 42 and the second metal braid 43 to reduce interferences between the second transmission line 4 and other transmission lines as well as reducing external interferences from other transmission lines to the second transmission line 4.

The third transmission line 5 is a specifically used in a third transmission interface (which is a RF transmission interface as shown in the figure, so that the third transmission line 5 is a RF coaxial cable used in this preferred embodiment), and has a third wire 51 and a third metal braid 52 covered onto the exterior of the third wire 51 to reduce interferences between the second transmission line 4 and other transmission lines as well as reducing external interferences from other transmission lines to the second transmission line 4.

The insulating tube 2 is a plastic tube passing into the hollow chamber 11 and further passing into a gap between the circularly arranged transmission lines (including the first transmission line 3, second transmission line 4 and third transmission line 5). In other words, the transmission lines are surrounded outside the insulating tube 2, such that when the composite cable 100 is squeezed or pressed by an external force, any one of the transmission lines can be prevented from being squeezed into the gap.

With reference to FIG. 2 for a sectional view of a composite cable of the second preferred embodiment of the present invention, the composite cable 600 is substantially the same as the composite cable 100 of the first preferred embodiment of the invention, except that the quantity and installation position of the second and third transmission lines 4, 5 are different from those of the first preferred embodiment.

In this preferred embodiment, the transmission lines include a plurality of first transmission lines 3, a second transmission line 4 and a plurality of third transmission lines 5, and the first transmission lines 3 and the third transmission lines 5 are arranged around the hollow chamber 11 and inside the hollow chamber 11, and the second transmission line 4 is passed into a gap of the circularly arranged first transmission lines 3 and third transmission lines 5. In other words, the first transmission lines 3 and the third transmission lines 5 are surrounded outside the second transmission line 4, such that when the composite cable 600 is squeezed or pressed by an external force, any one of the first transmission lines 3 or any one of the third transmission lines 5 can be prevented from being squeezed into the gap.

In summation of the description above, the present invention has the following advantages and effects over the prior art:

The interferences between the first, second and third transmission lines 3, 4, 5 can be reduced by the metal braid and the aluminum foil layer of the first, second and third transmission lines 3, 4, 5 (or even the external interferences can be reduced by the insulating outer layer 1 and the mylar layer 12 disposed at an inner edge of the outer layer 1), so that a same composite cable 100, 600 concurrently has at least two types of transmission lines (which are the first, second and third transmission lines 3, 4, 5 as illustrated in the first and second preferred embodiments), and the first, second and third transmission lines 3, 4, 5 are specifically used in the HDMI transmission interface, USB transmission interface and RF transmission interface respectively, so as to achieve the effects of not only providing a plurality of transmission lines (3, 4, 5) and a multiple of functions (such as digital video signal transmission, analog video signal transmission, data transmission, power transmission, etc) in the same composite cable 100, 600 at the same time, but also transmitting data by different transmission lines (3, 4, 5) in the same composite cable 100, 600 while reducing the interferences between the transmission lines (3, 4, 5), so as to assure and maintain the original high quality of video, audio or data signals.

In addition, the present invention provides other effects:

In the composite cable 100 of the first preferred embodiment, an insulating tube 2 is passed into a gap between the circularly arranged transmission lines (3, 4, 5), so that when the composite cable 100 is squeezed or pressed by an external force, any one of the transmission lines (3, 4, 5) can be prevented from being squeezed into the gap. In the composite cable 600 of the second preferred embodiment, a second transmission line 4 is passed into a gap between the circularly arranged first transmission lines 3 and third transmission lines 5, so that when the composite cable 600 is squeezed or pressed by an external force, any one of the first transmission lines 3 or any one of the third transmission lines 5 can be prevented from being squeezed into the gap.

In summation of the description above, the present invention achieves the expected objectives and overcomes the drawbacks of the prior art, and the invention complies with patent application requirements, and is thus duly filed for patent application.

While the invention has been described by means of specific embodiments, numerous modifications and variations could be made thereto by those skilled in the art without departing from the scope and spirit of the invention set forth in the claims.

What is claimed is:

1. A composite cable, comprising:
an insulating outer layer, having a hollow chamber; and
a plurality of transmission lines, passed into the hollow chamber, and each of the transmission lines being used specifically for a plurality of transmission interfaces, and the transmission lines comprising:
at least one first transmission line, having a plurality of first wires, a first aluminum foil layer covered onto the exterior of the first wires, a first metal braid covered onto the exterior of the first aluminum foil layer, and a first ground wire installed between the first aluminum foil layer and the first metal braid; and
at least one second transmission line, having at least one second wire and a second metal braid covered onto the exterior of the at least one second wire.

2. The composite cable of claim 1, wherein the at least one second transmission line further includes a second aluminum foil layer and a second ground wire, and the at least one second wire comes with a plural quantity, and the second aluminum foil layer is covered onto the exterior of the second wires, and the second metal braid covered onto the exterior of the the second wires with the second aluminum foil layer in between, and the second ground wire is installed between the second metal braid and the second aluminum foil layer.

3. The composite cable of claim 2, wherein the at least one first transmission line comes with a plural quantity, and the at least one second transmission line comes with a singular quantity, and the transmission lines further include at least one third transmission line, and the at least one third transmission line has a third wire and a third metal braid covered onto the exterior of the third wire.

4. The composite cable of claim 3, further comprising an insulating tube passing into the hollow chamber and surrounding around the transmission lines.

5. The composite cable of claim 3, wherein the transmission interfaces include a HDMI transmission interface, a USB transmission interface and a RF transmission interface, and each of the first transmission lines is a HDMI transmission line used for the HDMI transmission interface, and the second transmission line is a USB transmission line used for the USB transmission interface, and the at least one third transmission line is a RF coaxial cable used for the RF transmission interface.

6. The composite cable of claim 2, wherein the at least one first transmission line comes with a plural quantity and the at least one second transmission line comes with a singular quantity, and the transmission lines further include a plurality of third transmission lines, and each of the third transmission lines has a third wire and a third metal braid covered onto the exterior of the third wire.

7. The composite cable of claim 6, wherein the second transmission line is jointly surrounded by the first transmission lines and the third transmission lines.

8. The composite cable of claim 6, wherein the transmission interfaces include a HDMI transmission interface, a USB transmission interface and a RF transmission interface, and each of the first transmission lines is a HDMI transmission line used for the HDMI transmission interface, and the second transmission line is a USB transmission line used for the USB transmission interface, and the at least one third transmission line is a RF coaxial cable used for the RF transmission interface.

9. The composite cable of claim 1, wherein the insulating outer layer has a mylar layer attached onto an inner edge of the insulating outer layer.
